(19) United States
(12) Patent Application Publication
(10) Pub. No.: US 2008/0171168 A1
(43) Pub. Date: Jul. 17, 2008

(54) Component Molding Method, Resin Component And Component Molding Die

(76) Inventor: Takehiro Matsuda, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/660,365

(22) PCT Filed: Aug. 15, 2005
(86) PCT No.: PCT/JP05/14899

§ 371 Date: Sep. 25, 2007

(30) Foreign Application Priority Data
Aug. 20, 2004 (JP) 2004-241410

(51) Int. Cl. B29D 12/00

(52) U.S. Cl. 428/36.9; 264/328.12; 425/542

(57) ABSTRACT

The present invention provides a component molding method for increasing the strength of a resin component, such as a lens holder, used in manufacturing a lens drive unit, and also provides a resin component, and a component molding die.

An initial flow direction of a resin injected from a gate 9G, from which a resin is injected into a cavity C, is set to extend substantially along a direction in which stiffness and strength of the resin component is needed to be higher than that in any other direction, by hitting the resin injected from the gate 9G against an inclined inner wall surface 33a of an inner wall of the cavity C to thereby change the flow direction almost 90° .

### TECHNICAL FIELD

The present invention relates to a component molding method, a resin component, and a component molding die.

### BACKGROUND ART

Various holders for holding various machine components, especially, small devices and components used in the devices, are manufactured by injection-molding, from the viewpoint of pursuing low-cost capability and productivity. One of the holders is what is called a lens holder that holds an object lens for optically recording information on and reproducing information from a disk-like information recording medium, such as a CD (Compact Disk), a DVD (Digital Video Disk or Digital Versatile Disk), or MD (Mini Disk).

This lens holder has a role as an important component of a lens drive unit for electro magnetically driving an object lens in what is called a pickup device in a focusing direction and a tracking direction to thereby control the position of the object lens.

That is, the lens holder needs to surely hold the object lens so that the object lens is able to accurately follow an information track of a disk-like information recording medium to optically record information on or reproduce information from the information recording medium.

The above-described lens drive unit has a configuration in which the lens holder, to which the object lens is attached, is attached to a suspension base through a holder suspension consisting of a plurality of elastic wires. Also, a drive current is fed to the focusing coil or the tracking coil to there by generate a magnetic field. According to Fleming's left-hand rule, an electromagnetic force is generated in a direction perpendicular to an electric current and to a magnetic field. The lens holder (together with the object lens) suspend-supported is displaced in the focusing direction or the tracking direction to thereby implement focusing servo or tracking servo.

Thus, the lens drive unit includes the lens holder which is a delicate precision component. Accordingly, high precision is demanded in manufacturing (or assembling) the lens holder.

Under such circumstances, the resinification of members, such as the lens holder for holding the optical components of an optical pickup, has hitherto been performed by reason of reduction in the weight and price of the members. Also, for pursuing a lightweight high-stiffness material having a low mold shrinkage factor, and a low linear expansion coefficient, a material including a substance and an additive, which have relatively long molecular chain, is more frequently selected as a resin material to be used. Especially, the case increases where the lens drive unit (also serving as the lens holders) as disclosed in the following Patent Document 1 employs a high-function engineering plastic material using a high-damping-capacity liquid crystal polymer mixed with an additive (a glass filler or a carbon filler) so as to suppress resonance at a characteristic frequency of the lens holder (or bobbin) itself.

It is generally known that each high-function engineering plastic material has what is called anisotropy in mechanical performance (bending elastic modulus) between a resin flow direction and a direction perpendicular to the resin flow direction.

### Patent Document 1: JF-A-2001-148131

### DISCLOSURE OF THE INVENTION

### Problems that the Invention is to Solve

The inventor of the present invention has studied and revealed that the lens holder used in the manufacture of the lens drive unit and the processing techniques of the lens holder have the following problems which will be described with reference to FIGS. 1 to 5.

FIG. 1 illustrate a lens drive unit configured to drive an object lens used for optically recording information on and reproducing information from a disk-like information recording media, such as a CD, a DVD, and an MD.

The lens drive unit 1 has a carriage 2 supported movably in a predetermined direction, a stationary portion 3 mounted on the carriage 2, and a lens holder 5 attached to the stationary portion 3 through an elastic wire 4. Also, the lens drive unit 1 is configured so that a medium to be scanned, for example, an optical disk 10, to record information there on and to reproduce information therefrom is mounted at an upper portion of the lens drive unit 1, and that a predetermined operation can be performed on the optical disk 10.

Further, as shown in FIG. 2, a lens drive unit moving part 1a is able to swing in the focusing direction (which is perpendicular to a surface of the disk and is designated by Fcs in FIG. 2) to appropriately maintain the distance from the optical disk 10 to a lens (not shown) mounted in a lens mounting hole 6. Also, the lens drive unit moving portion 1a is able to swing in the tracking direction (which is a disk radius direction and is designated by Trk in FIG. 2) to appropriately follow a recording track on the optical disk 10.

It is known that when the lens drive unit moving portion 1a swings in a follow-up direction in which the lens drive unit moving portion 1a follows the recording track, in a case where the stiffness in the direction perpendicular to the follow-up direction of the lens drive unit moving part 1a is insufficient, there is a fear of generating unnecessary resonances to deteriorate servo characteristics.

Incidentally, a direction, in which stiffness is needed during tracking driving, is a disk tangent direction of the disk, along which a tracking coil is wound. The dimension in the disk tangent direction of the lens drive unit moving part 1a is short, as compared with that in the disk radius direction thereof. Therefore, it can be expected to obtain high bending stiffness. Actually, it hardly causes a problem.

However, the dimension and the stiffness thereof in a direction (the disk radius direction), in which stiffness is needed during focusing driving, are long and low, as compared with those thereof in the disk tangent direction, respectively. Heavy objects (the tracking coils 7 in this case) are wound around both ends in the disk radius direction of the lens drive unit moving part 1a, so that a load applied thereto increases. Accordingly, there is a fear of occurrence of unnecessary large resonances at a low frequency due to vibrations generated while the lens drive unit 1 operates.

To manufacture the lens holder S as shown in FIG. 3, it is necessary to form the shape of the lens mounting hole 6, into which the lens is inserted, with good precision. A molding die 15 has a structure configured to open in an up-down direction with a boundary of a parting line P as shown in FIG. 4. The position of a gate 9G is set at a place close to a corner of the lens holder S to form the lens holder 5.

When injection-molding is performed, resin injected from the gate 9G randomly spreads into a cavity C formed by an upper die 41 and a lower die 42. Thus, a molding method using a conventional die has problems in that a resin flow direction is unstable, and that a lens holder having a stable strength cannot be manufactured.

Especially, the high-function synthetic resin containing an additive to increase the strength has a conspicuous anisotropy of the strength that varies depending upon the resin flow direction at molding. Thus, as described above, each of the direction, in which stiffness is needed, and an inflow direction (the resin flow direction), in which the resin flows into the cavity from the gate 9G, cannot be controlled to coincide with a desired direction. The conventional lens holder has a problem in that the stiffness in a desired direction significantly differs from an original value of the stiffness of the resin.

Meanwhile, when the stiffness of the lens drive unit moving part degraded due to the anisotropy is compensated by the shape thereof, for example, the mechanical performance of a lens holder 20 shown in FIG. 5 can be enhanced by providing a thickness increasing portion 21 therein to increase the thickness and the width in the direction (that is, a direction along the tracking coil mounting groove 25A), in which the stiffness is needed, (by a thickness t).

However, when the strength is increased by increasing the thickness of the lens drive unit moving part, an amount of the resin is increased, with the result of increase in the weight of the lens drive unit moving part. Thus, in the case of the lens drive unit 1 required to make a quick response, the sensitivity of the lens drive unit is decreased. This causes undesirable results such as resistance of performance improvement of, for example, double-speed recording/reproducing or reduction in performance of the reproduction of an inferior disk.

Also, when the weight of the lens drive unit 1 increases due to the increase of the thickness of the lens holder 20, the weight of the pickup apparatus is also increased. This causes harmful effects that a burden is imposed on a pickup feed mechanism, that power consumption is increased, and that search time is increased.

Additionally, when the stiffness is compensated by changing the grade of the resin material, a large amount of an additive is mixed into the resin material. This results into not only further enhancement of the anisotropy but also increase in specific gravity of the resin material. Consequently, the weight of the resin material increases. This causes negative effects similar to the aforementioned harmful effects.

An example of the problems to be solved by the invention is the aforementioned problem of the stiffness and the strength of resin components, such as the lens holder used in the lens drive unit.

### Means for Solving the Problems

The invention according to claim 1 provides a component molding method adapted so that when a resin component is formed by injection-molding, an initial flow direction of a resin injected from a gate, from which a resin is injected into a cavity, is set to be substantially along a predetermined direction.

The invention according to claim 6 provides a resin component formed by injection molding. The resin component features that an inclined outer wall surface is formed at a place opposed to a gate mark, and that the inclined outer wall surface has an inclination angle at which an initial flow direction of the resin injected into the cavity at molding of the resin component is changed to a direction extending substantially along a predetermined direction.

The invention according to claim 10 provides a resin component formed by injection molding. The resin component features that a gate mark is provided at a position from which a resin is enabled to be injected so that a direction of the resin injected from a gate at molding of the resin component is set to be along a predetermined direction.

The invention according to claim 13 provides a component molding die for injection molding of a resin component. The component molding die features that an inclined inner wall surface is formed at a place opposed to a gate from which a resin is injected, and that the inclined inner wall surface has an inclination angle at which an initial flow direction of the resin injected into the cavity at molding of the resin component is changed to a direction extending substantially along a predetermined direction.

The invention according to claim 14 provides a component molding die for injection molding of a resin component. The component molding die features that a gate, from which a resin is injected laterally with respect to a die opening direction, is provided, and that an initial flow direction of the resin injected from the gate is set to extend substantially along a predetermined direction.

### BRIEF DESCRIPTION OF THE DRAWINGS

FIG. 1 is a perspective view illustrating a primary part of a conventional lens drive unit.

FIG. 2 is a perspective view illustrating the movement of each of a lens drive unit moving portion and a holder shown in FIG. 1.

FIG. 3 is a perspective view illustrating a conventional holder.

FIG. 4 is a cross-sectional view illustrating a die for molding the holder shown in FIG. 3.

FIG. 5 is a plan view illustrating a reinforcing structure of the conventional holder.

FIG. 6 is a perspective view illustrating a holder of a first embodiment of the invention.

FIG. 7 is a cross-sectional view illustrating a die, which is taken along line X-X in the holder shown in FIG. 6.

FIG. 8 is a primary part enlarged cross-sectional view illustrating an operation according to the invention.

FIG. 9 is a perspective view illustrating a holder according to a second embodiment of the invention.

FIG. 10 is a cross-sectional view illustrating a die, which is taken along line X-X in the holder shown in FIG. 9.

FIG. 11 is a perspective view illustrating a holder according to a third embodiment of the invention.

FIG. 12 is a perspective view illustrating the holder according to the third embodiment of the invention.

FIG. 13 is a cross-sectional view illustrating a die, which is taken along line X-X in the holder shown in FIG. 11.

FIG. 14 is a perspective view illustrating a holder according to a fourth embodiment of the invention.

FIG. 15 is a perspective view illustrating the holder according to the fourth embodiment of the invention.

FIG. 16 is a cross-sectional view illustrating a die, which is taken along line X-X in the holder shown in FIG. 15.

FIG. 17 is a perspective view illustrating a holder according to a fifth embodiment of the invention.

FIG. 18 is a cross-sectional view illustrating a die, which is taken along lines X-X and Y-Y in the holder shown in FIG. 17.

FIG. 19 is a perspective view illustrating a holder according to a sixth embodiment of the invention.

FIG. 20 is a cross-sectional view illustrating a die, which is taken along lines X-X and Y-Y in the holder shown in FIG. 19.

FIG. 21 is a schematic plan view illustrating the holder shown in FIG. 19.

FIG. 22 is a schematic plan view illustrating a holder according to a comparative example.

FIG. 23 is a perspective view illustrating a holder according to a seventh embodiment of the invention.

FIG. 24 is a cross-sectional view illustrating a die, which is taken along line X-X in the holder shown in FIG. 23.

### DESCRIPTION OF REFERENCE NUMERALS AND SIGNS

6 lens mounting hole
9 gate mark
9G gate
30, 40, 50, 60, 70, 80, 90 holders
33, 43, 53, 63 inclined outer wall surfaces
33a, 43a, 53a, 63a inclined inner wall surfaces
35, 45, 55, 65, 75, 85, 95 dies
S1 first resin flow
S2 second resin flow
S3 third resin flow
P parting line

### BEST MODE FOR CARRYING OUT THE INVENTION

Hereinafter, embodiments of the invention are described in detail.

In a component molding method according to the invention, when a resin component is formed by injection-molding, an initial flow direction of a resin injected from a gate, from which a resin is injected into a cavity, is set to be substantially along a predetermined direction.

Also, the predetermined direction corresponding to a direction in which stiffness of the resin component is needed to be higher than that in any other direction.

Thus, the initial flow direction of the resin injected into the cavity is set to be substantially along a direction in which stiffness of the resin component is needed to be higher than that in any other direction. Consequently, a molecular chain as an additive included in the resin can be oriented. Accordingly, the original stiffness and strength of the resin can be derived maximally. Incidentally, the initial flow direction is defined as a flow direction in which an injected resin flows before the resin spreads in the cavity all-around, for example, a direction of a resin flow in an area that is a substantially half the maximum distance by which the resin flows in the cavity.

Also, more specifically, according to the component molding method according to an embodiment of the invention, as shown in FIG. 8, means for determining an initial flow direction of a resin is adapted to hit a resin injected from a gate 9G to an inclined inner wall surface 33a of the inner wall of a cavity C to thereby change the flow direction almost 90°.

Thus, a resin flow flowing in a desired direction can easily be formed by the inclined inner wall surface 33a of the inner wall surface of the cavity C.

In the component molding method according to an embodiment of the invention, means for determining the initial flow direction is adapted so that the direction of the resin injected from the gate 9G is preliminarily adjusted to the direction in which the stiffness and the strength are necessary.

With such setting, the resin flow direction can be determined by a first injection direction of injection from the gate 9G without changing the resin flow direction by the inclined inner wall surface or the like.

The resin component according to an embodiment of the present invention is formed by injection molding. Each of the inclined outer wall surfaces 33, 43, 53, and 63 is formed at a place facing the gate mark 9 on a corresponding one of the holders 30, 40, 50 and 60 for holding the predetermined component. Each of the inclined outer wall surfaces 33, 43, 53, and 63 has an inclination angle, by which the initial flow direction of the resin injected into the cavity C at molding of the corresponding holder 30, 40, 50, or 60 is changed to a direction extending substantially along a direction in which stiffness of the resin component is needed to be higher than that in any other direction. Especially, the inclination angle of the inclined outer wall surface is preferably set at substantially 45° with respect to the flow direction of the resin injected from the gate 9G. The position of the inclined outer wall surface, which is located in the direction of the height of the holder, depends upon the shape of the cavity of the die. Preferably, this position of the inclined outer wall surface is roughly in the vicinity of the center in the direction of the height of the holder.

The resin component according to an embodiment of the invention is formed by injection molding. In the holder 90 for holding a predetermined component, a gate mark 9 is provided at a position so that the direction of the resin injected from the gate 9G at molding of the holder is preliminarily set to a direction extending along a direction in which the stiffness and the strength are necessary for the holder.

With this configuration, the resin flow direction can be determined by the direction of an initial injection of the resin from the gate 9G without changing the resin flow direction by the inclined inner wall surface and so on.

The resin component according to an embodiment of the invention is applied to a lens drive unit, which is a holder for holding a lens serving as a predetermined component and which holds the lens and is swingably attached to a suspension base through an elastic wire and is driven in the focusing direction of the lens and in the tracking direction of a scanned medium.

Thus, the holder, which is the resin component according to the invention, is applied to the lens drive unit. Consequently, the lens drive unit is adapted to have a necessary strength and to be lightweight. When the lens drive unit required to make a quick response, the performance improvement of double-speed recording/reproducing can be improved without reducing the sensitivity thereof. The performance of the reproduction of an inferior disk can be enhanced.

Also, it is unnecessary to increase the thickness of the holder. The weight of the pickup is not increased. A burden is not imposed on the pickup feed mechanism. The power consumption can be prevented from being increased. Also, the stiffness enhancement can easily be achieved without upgrading the resin material.

A component molding die according to the embodiment of the invention is a component molding die for injection molding of a resin component, which is configured so that an inclined inner wall surface is formed at a place opposed to a gate from which a resin is injected, and that the inclined inner wall surface has an inclination angle at which an initial flow direction of the resin injected into the cavity at molding of the resin component is changed to a direction extending substantially along a predetermined direction.

According to the component molding die configured in this manner, the direction of the resin injected from the gate can be set to extend along a predetermined direction.

A component molding die according to an embodiment of the invention for injection molding of a resin component is configured so that a gate, from which a resin is injected laterally with respect to a die opening direction, is provided, and that an initial flow directions of the resin injected from the gate is set to extend substantially along a predetermined direction.

With this configuration, the resin flow direction can be determined by the direction of the first injection of the resin from the gate, without changing the resin flow direction by the inclined surface, by preliminarily adjusting the direction of the resin injected from the gate to a predetermined direction.

### FIRST EMBODIMENT

Hereinafter, a first embodiment of the invention is described with reference to FIGS. 6 to 8.

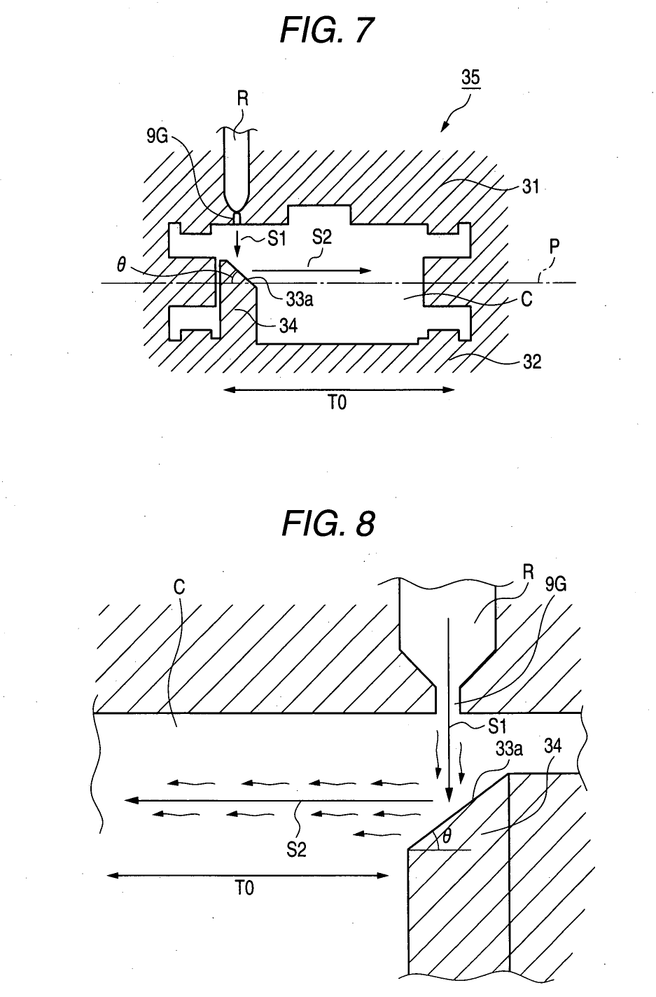

FIG. 6 is a perspective view illustrating a holder of the first embodiment of the invention. FIG. 7 is a cross-sectional view illustrating a molding die, which is taken along line X-X in the holder shown in FIG. 6. FIG. 8 is a primary part enlarged cross-sectional view illustrating an operation of the present embodiment.

A holder (resin component) 30 according to the first embodiment shown in FIG. 6 is a lens holder applied to a lens drive unit as a member for holding a lens (predetermined component) in an information recording/reproducing apparatus, such as a CD player, a DVD player, and an MD player.

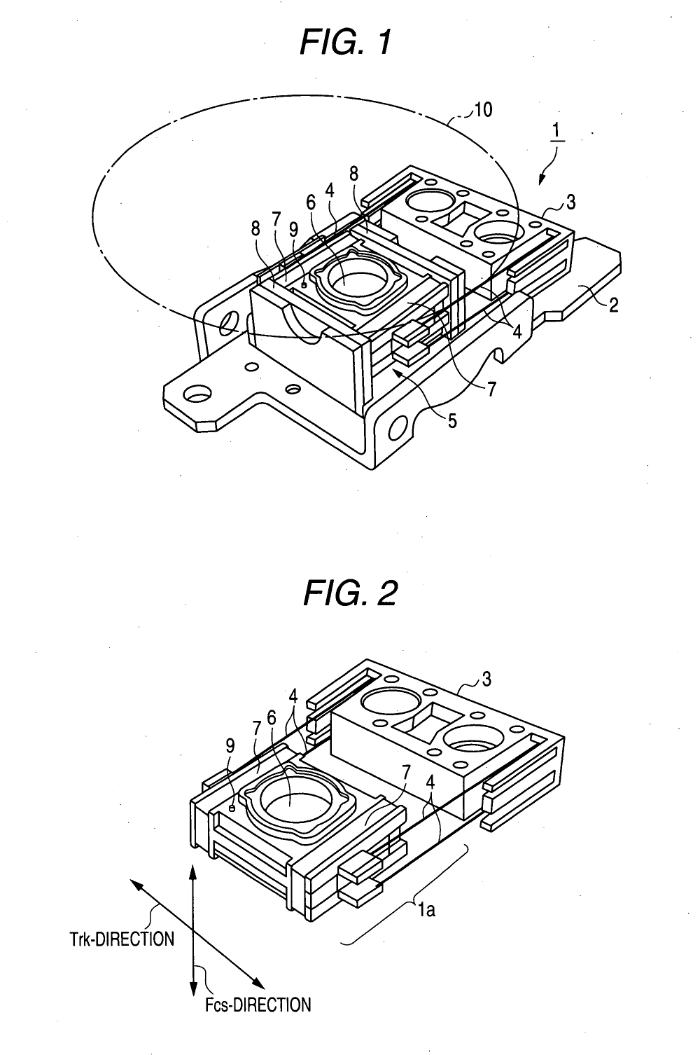

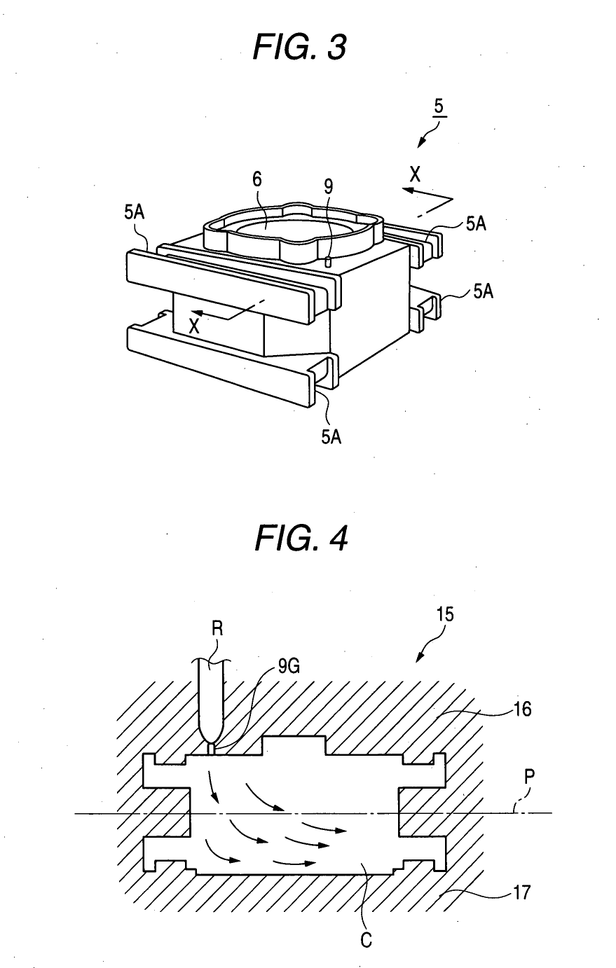

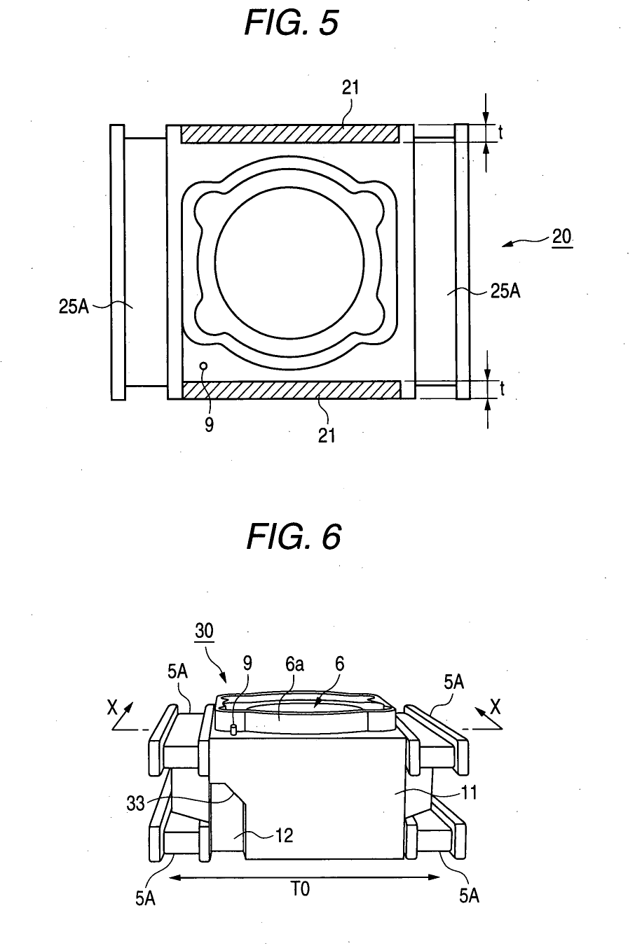

Incidentally, the structure or basic configuration of the lens drive unit employing the holder 30 according to the present embodiment is similar to that of the conventional lens drive unit shown in FIGS. 1 and 2. That is, the lens drive unit according to the present embodiment is configured so that the holder 30 for holding a lens is swingably attached to a suspension base 3 through, for example, four elastic wires 4 as shown in FIG. 2. The lens unit is driven in the focusing direction of the lens and in the tracking direction of a disk 10 by the action of a magnet 8, a tracking coil 7 and a focusing coil (not shown)

This holder 30 is formed by performing injection molding using a material that is a high function synthetic resin, for example, obtained by adding glass filler or carbon filler to a liquid crystal polymer.

This holder 30 has a lens mounting hole 6 at the central portion thereof and to has a substantially rectangular-cylinder-like outer shape. Also, the holder 30 has appropriately concaved tracking coil mounting grooves 5A around which a tracking coil 7 (see FIG. 2) is wound, respectively provided in both end portions so as to sandwich the lens mounting hole 6.

Also, a gate mark 9 is provided in the vicinity of a corner portion (the left side in FIG. 6) outside an annular convex portion 6a formed on the top surface (the upper side in FIG. 6) of the holder to surround the lens mounting hole 6. Also, a concave portion 12 having an inclined outer wall surface 33 is formed at a position opposed to the gate mark 9 on an outer wall surface 11 close to the gate mark 9.

The holder 30 is provided with the inclined outer wall surface 33. Thus, the holder 30 is configured so that the stiffness and the strength are high in a direction T0 extending along the outer wall surface 11 of the holder 30, in which the stiffness and the strength are needed, due to the resin flow direction (to be described later) at molding.

As shown in FIG. 7, a molding die (component molding die) 35 for manufacturing the holder 30 is configured so that an upper die 31 and a lower die 32 are opened from each other along the parting line P in an up-down direction (a direction in which the lens mounting hole 6 penetrates through the holder ), The gate 9G is constituted by a pin gate connected to a runner R of the upper die 31. A protruding wall 34 is provided at the place opposed to the gate 9G to project into the cavity C. Also, the protruding wall 34 has a surface facing the gate 9G that constitutes an inclined inner wall surface 33a inclined in a predetermined direction. Additionally, the position in the direction of height of the inclined inner wall surface 33a (in an up-down direction in FIG. 7) in the cavity C is set to be slightly higher than the central position. According to the present embodiment, an inclination angle θ is set to be inclined by substantially 45° with respect to the parting line P (in the horizontal direction of the holder 30).

A method of molding the holder 30 employing the molding die 35 having this configuration is described below.

First, as shown in FIG. 8, a molten resin is injected into the cavity C of the molding die 35 from the gate 9G as a first flow S1, the direction of injection of which is the up-down direction with respect to the holder 30.

The first flow S1 output from the gate 9G collides immediately with the inclined inner wall surface 33a, so that a second flow S2 is formed according to the setting of the inclination angle of the wall surface 33a. Thus, the second flow S2 is caused by the action of the inclined inner wall surface 33a to flow substantially along the direction T0 serving as an initial flow direction, in which the stiffness and the strength are needed. That is, the resin injected in the cavity C at molding the holder is filled into the cavity C until the cavity C is filled up with the resin, while the initial flow direction is changed to a direction substantially extending along a direction in which stiffness and strength of the holder 30 is needed to be higher than that in any other direction.

After completion of filling the cavity with the resin and appropriately cooled, the molding die 35 is opened to take the holder 30 out of the mold 35. At that time, the gate 9G according to the present embodiment is a pin gate. Thus, when the holder 30 is taken out of the molding die 35, the pin gate can easily be cut off, so that the gate mark 39 is formed.

Thus, according to the present embodiment, the resin injected from the gate 9G does not randomly spread but flow nearly along the direction T0, in which the stiffness and the strength are necessary while filled into the cavity. Consequently, the strength in a desired direction of the holder can be achieved by positively utilizing the anisotropy in the mechanical performance (bending elastic modulus or the like) between the resin flow direction and a direction perpendicular to the resin flow direction.

When the tracking coil and the focusing coil are attached to the holder 30 molded in this manner, and where the holder 30 is applied to the lens drive unit, as shown in FIG. 1, the strength in the tracking direction is increased, as compared with the conventional holder. The holder according to the present embodiment is small and has sufficient strength, as compared with the conventional holder. Thus, the reduction in weight of the holder can easily be achieved. Consequently, when the lens drive unit is required to make a quick response, the performance improvement of double-speed recording/reproducing can be improved without reducing the sensitivity thereof. The, performance of the reproduction of an inferior disk can be enhanced.

### SECOND EMBODIMENT

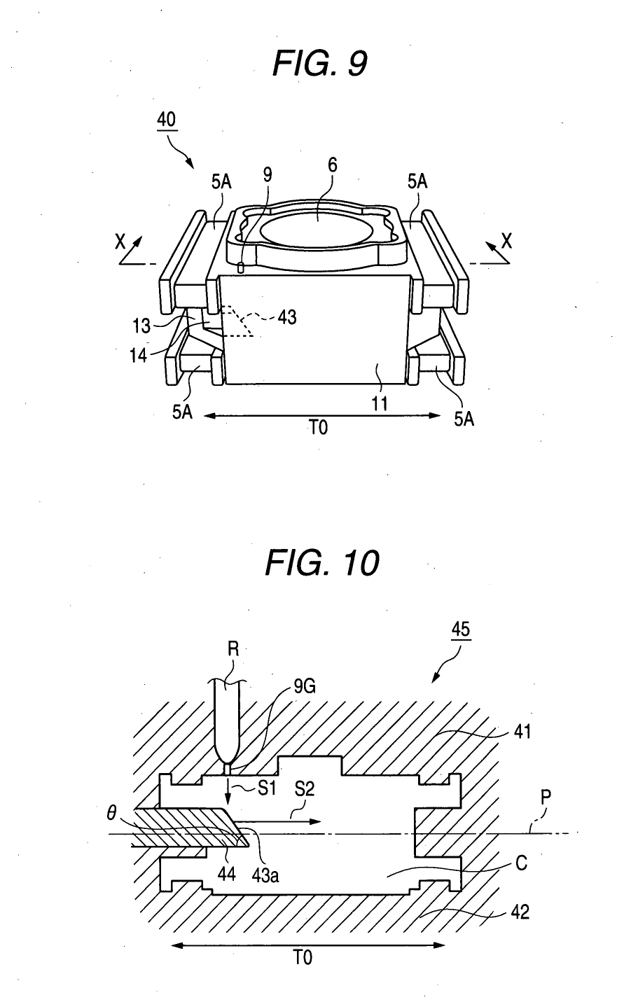

Hereinafter, a second embodiment of the invention is described with reference to FIGS. 9 and 10.

FIG. 9 is a perspective view illustrating a holder according to the second embodiment of the invention. FIG. 10 is a cross-sectional view illustrating a molding die, which is taken along line X-X in the holder shown in FIG. 9.

Incidentally, in FIGS. 9 and 10, each composing element of the present embodiment, which is similar to a corresponding element of the first embodiment, is designate by the same reference numeral.

A holder (resin component) 40 according to the present embodiment is similar in the position of the gate mark 9 and the remaining composing elements to the holder of the first embodiment. However, the holder 40 according to the present embodiment differs from the holder of the first embodiment in that a concave portion 14 having an inclined outer wall surface 43 formed at the position facing the gatemark 9 is formed. That is, the concave portion 43 having the inclined outer wall surface 43 of the present embodiment is configured to be laterally depressed between the tracking coil mounting grooves 5A, 5A arranged in the up-down direction of the holder.

Similarly to the first embodiment, the holder 40 is configured so that the stiffness and the strength are high in the direction T0, in which the stiffness and the strength are needed for the holder, along the outer wall surface 11 of the holder 40.

As shown in FIG. 10, a molding die (component molding die) 45 for manufacturing the holder 40 is configured so that an upper die 41 and a lower die 42 are opened from each other along the parting line P in an up-down direction of the holder 40. The gate 9G is constituted by a pin gate connected to a runner R of the upper die 41.

A slide core 44 is protruded at the place opposed to the gate 9G to project into the cavity C (in the leftward direction, as viewed in FIG. 10). Also, the slide core 44 has an inclined inner wall surface 43a whose end surface facing the gate 9G is inclined in a predetermined direction. Similarly, in the present embodiment, an inclination angle θ is set to be inclined by substantially 45° with respect to the parting line P. The inclined inner wall surface 43a according to the present embodiment has effects similar to those of the inclined inner wall surface 33a according to the first embodiment.

Additionally, the slide core 44 is slide-moved (along the parting line P) at molding of the holder 40 to recede from the cavity C before the molding die 45 is opened. Consequently, the holder 40 serving as a resin component can be taken out of the molding die 45. Also, according to the slide core 44, the size of the concave portion 14 to be formed to form the inclined inner wall surface 43a can be reduced in size as much as possible.

### THIRD EMBODIMENT

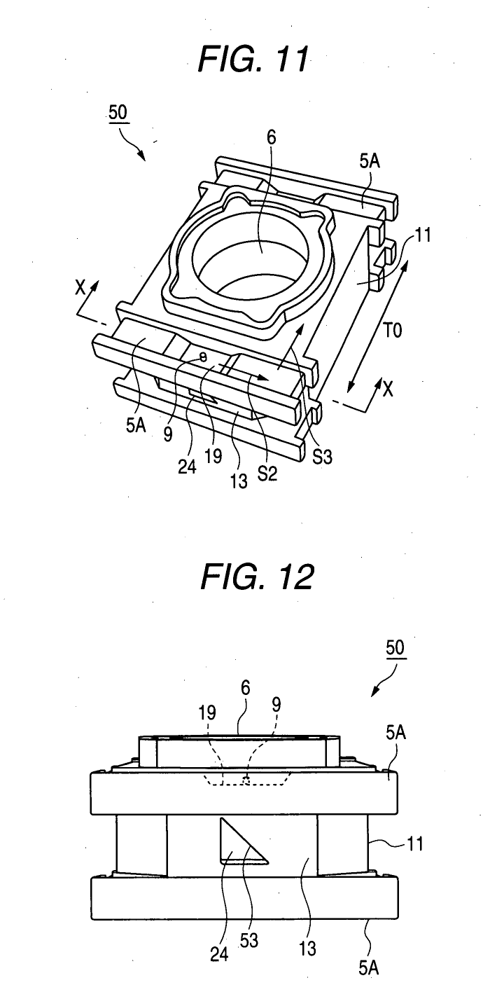

Hereinafter, a third embodiment of the invention is described with reference to FIGS. 11 to 13.

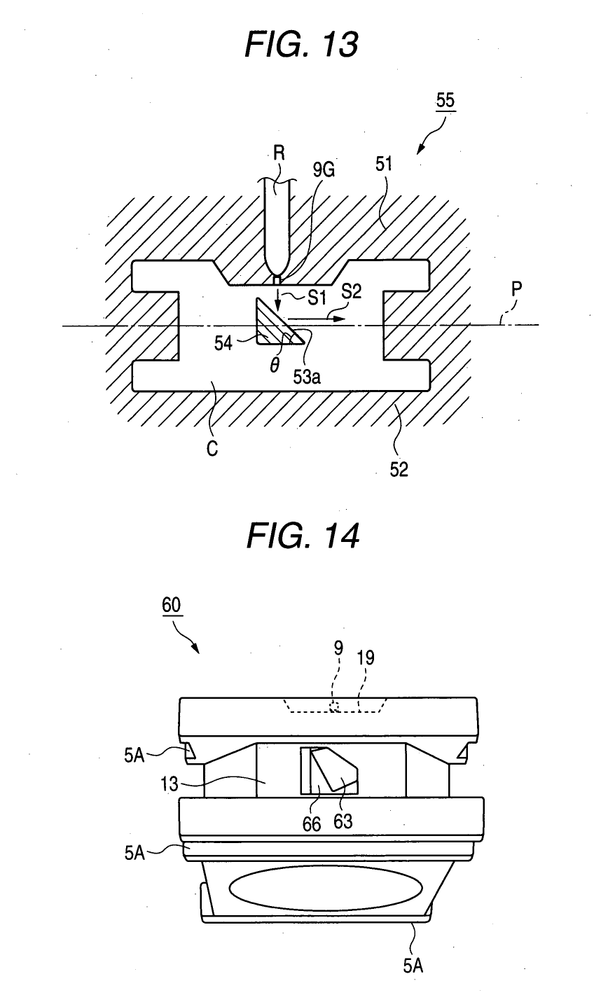

FIGS. 11 and 12 are perspective views illustrating the holder according to the third embodiment. FIG. 13 is a cross-sectional view illustrating a molding die, which is taken along line X-X in the holder shown in FIG. 11.

Incidentally, in FIGS. 11 to 13, each composing element of the present embodiment, which is similar to a corresponding element of the first embodiment, is designate by the same reference numeral.

A holder (resin component) 50 according to the present embodiment is configured similarly to the second embodiment, except the positions and the shapes of the gate mark 9 and the slide core.

Speciffically, the gate mark 9 according to the present embodiment is formed substantially at the center in the longitudinal direction of each of the tracking coil mounting grooves 5A. Also, the gate mark 9 is formed in a further concave depression portion 19 that is provided in each of the tracking coil mounting grooves 5A. The gate mark 9 is configured without hindrance to winding of the tracking coils therearound, A concave portion 24, which is made by removing the slide core 54 (see FIG. 13) to be empty and has an inclined outer wall surface 53, is configured like a triangle.

Similarly to the second embodiment, the holder 50 is configured so that the stiffness and the strength are high in the direction T0, in which the stiffness and the strength are needed for the holder, along the outer wall surface 11 of the holder 50.

As shown in FIG. 13, a molding die (component molding die) 55 for manufacturing the holder 50 is configured so that an upper die 51 and a lower die 52 are opened from each other along the parting line P in an up-down direction of the holder 50. The gate 9G is constituted by a pin gate connected to a runner R of the upper die 51. A slide core 54 has a transversally cross-sectionally triangle-shaped and is protruded at the place opposed to the gate 9G to project into the cavity C (in the rear side of paper in FIG. 13). Also, the slide core 44 has an inclined inner wall surface 53a inclined in a rightward direction in FIG. 13.

In the present embodiment, an inclination angle of the inclined inner wall surface 53a is set to be inclined by substantially 45° with respect to the parting line P. Similarly to the inclined inner wall surface 43a according to the second embodiment, the inclined inner wall surface 53a according to the present embodiment generates a second flow S2 by changing the direction of the first flow S1 of the resin injected from the gate 9 by 90°. After the second flow S2 flows toward the inner side wall (constituting the outer wall surface 11) of the cavity C, the direction of the second flow S2 is changed 900 along this inner side wall, so that a third flow S is formed (see FIG. 11). Thus, the injected resin flows into the cavity C.

According to such a slide core 54, the size of the concave portion 24 formed to form the inclined inner wall surface 53a can be further reduced, as compared with the second embodiment.

### FOURTH EMBODIMENT

Hereinafter, a fourth embodiment of the invention is described with reference to FIGS. 14 to 16.

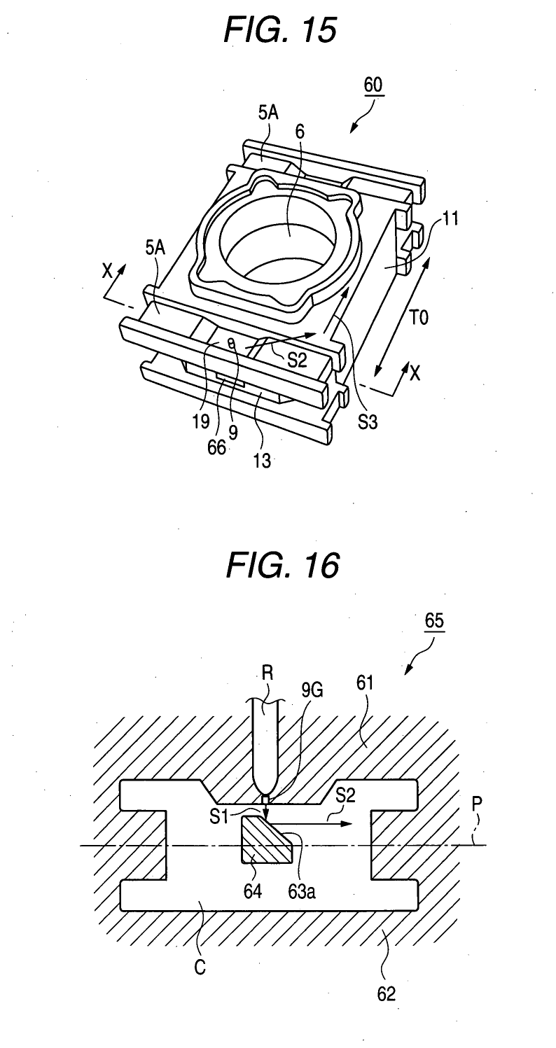

FIGS. 14 and 15 are perspective views illustrating the holder according to the third embodiment. FIG. 16 is a cross-sectional view illustrating a die, which is taken along line X-X in the holder shown in FIG. 15.

Incidentally, in FIGS. 14 to 16, each composing element of the present embodiment, which is similar to a corresponding element of each of the above embodiments, is designate by the same reference numeral.

A holder (resin component) 60 according to the present embodiment is configured similarly to the third embodiment, so that the position of the gate mark 9 is the same as the position of the gate mark of the third embodiment, except the shape of the slide core.

That is, a concave portion 66, from which the slide core 64 is removed, has an inclined outer wall surface 63 corresponding to an end portion of the core. The inclined outer wall surface 63 extends obliquely to the up-down direction of the holder 60 and to the longitudinal direction of the tracking coil mounting groove 5A.

Incidentally, similarly, the gate mark 9 according to the present embodiment is formed in a further concave depression portion 19 that is provided in each of the tracking coil mounting grooves 5A. Also, the gatemark 9 is configured without hindrance to winding of the tracking coils therearound.

Similarly to the above embodiments, the holder 60 is configured so that the stiffness and the strength are high in the direction T0, in which the stiffness and the strength are needed for the holder, along the outer wall surface 11 of the holder 60.

As shown in FIG. 16, a molding die (component molding die) 65 for manufacturing the holder 60 is configured so that an upper die 61 and a lower die 62 are opened from each other along the parting line P in the up-down direction of the holder 60. The gate 9G is constituted by a pin gate connected to a runner R of the upper die 61. A slide core 64 is protruded at the place opposed to the gate 9G to project into the cavity C (in the rear side of paper, on which FIG. 16 is drawn).

Additionally, the slide core 64 according to the present embodiment is configured so that the inclined inner wall surface 63a is inclined to both the long side direction and the short side direction of the holder, and is also inclined by substantially 45° with respect to the up-down direction of the holder.

With such a configuration, the slide core 64 mounted in the molding die 65 is such that the inclined inner wall surface 63a formed at an end portion of the slide core 64 changes a first flow S1 (the flow shown in FIG. 16 flowing downwardly from the holder) of the resin injected from the gate 9 to the horizontal flow flowing along the parting line, that the inclined inner wall surface 63a forms a second flow S2 flowing obliquely to the long side direction of the holder (see FIGS. 15 and 16), and that subsequently, the inclined inner wall surface 63a forms a third flow S3 (see FIG. 15) flowing along the outer wall 11, while the resin is filled into the cavity.

### FIFTH EMBODIMENT

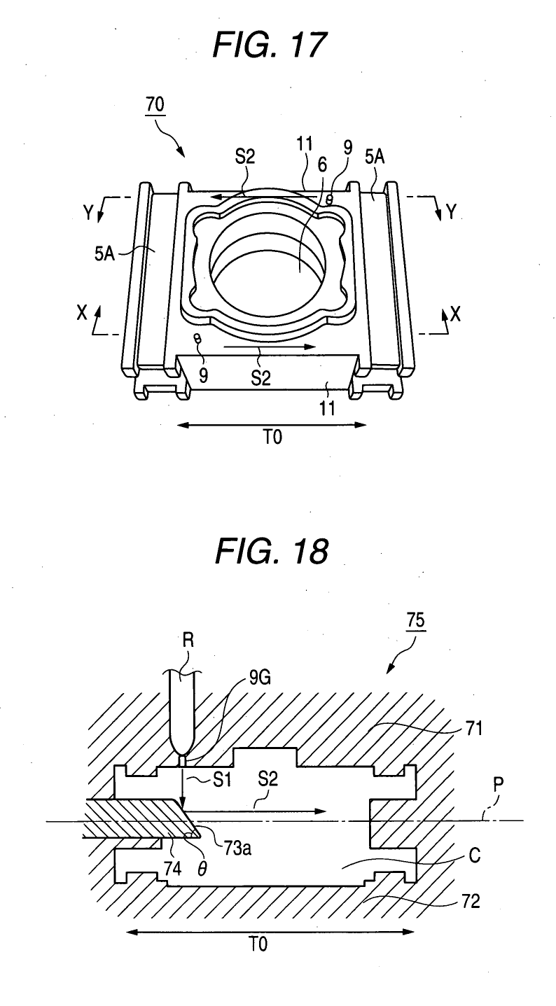

Hereinafter, a fifth embodiment of the invention is described with reference to FIGS. 17 and 18.

Incidentally, in FIGS. 17 and 18, each composing element of the present embodiment, which is similar to a corresponding element of the second embodiment, is designate by the same reference numeral.

A holder (resin component) 70 and a molding die (component molding die) 75 are configured similarly to those of the second embodiment, respectively, except that each of the holder 70 and the molding die 75 is of the twin gate type. That is, two inclined outer wall surfaces (not shown, see FIG. 9), each of which is the same as the inclined outer wall surfaces according to the second embodiment are formed at two places opposed to gate marks 9, 9, respectively.

Similarly to the second embodiment, the holder 70 is configured so that the stiffness and the strength are high in the direction T0, in which the stiffness and the strength are needed for the holder, along the outer wall surface 11 of the holder 70.

As shown in FIG. 18, a molding die 75 for manufacturing the holder 70 is configured so that an upper die 71 and a lower die 72 are opened from each other along the parting line P in an up-down direction of the holder 70. The gate 9G is constituted by a pin gate connected to a runner R of the upper die 71.

A slide core 74 is protruded at the place opposed to the gate 9G to project into the cavity C (in the rightward direction in FIG. 18). Also, the slide core 74 has an inclined inner wall surface 73a whose end surface facing the gate 9G is inclined in a predetermined direction.

Similarly, in the present embodiment, an inclination angle θ is set to be inclined by substantially 450 with respect to the parting line P. The inclined inner wall surface 43a according to the present embodiment has effects similar to those of the inclined inner wall surface 33a according to the second embodiment.

Also, the fifth embodiment forms two flows S2 and S3 flowing in substantially parallel to the direction T0 in which the stiffness and the strength are needed for the holder. Thus, the present embodiment can provide the holder 70 that excels in strength.

### SIXTH EMBODIMENT

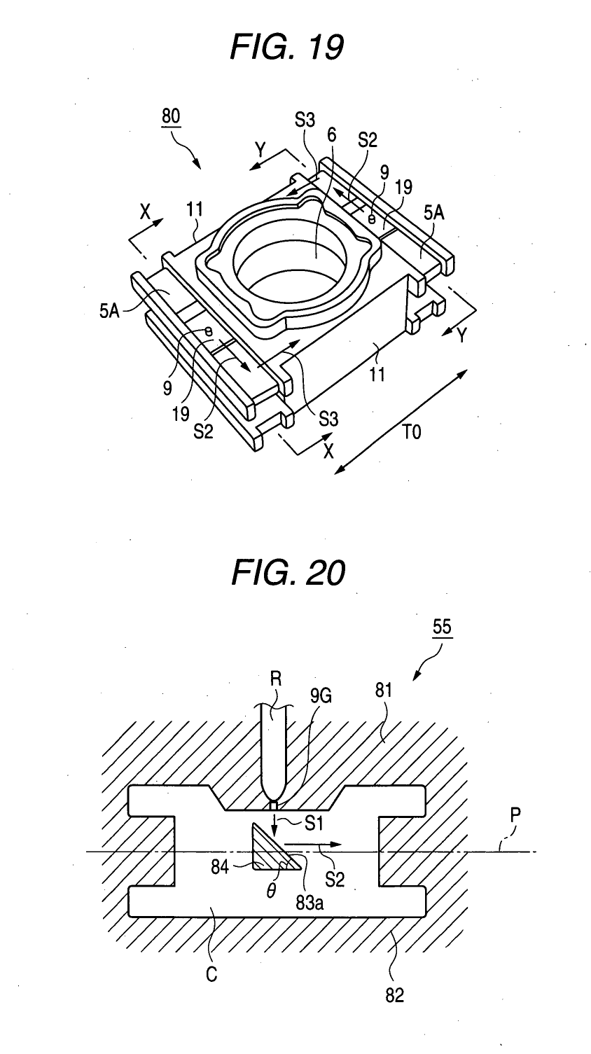

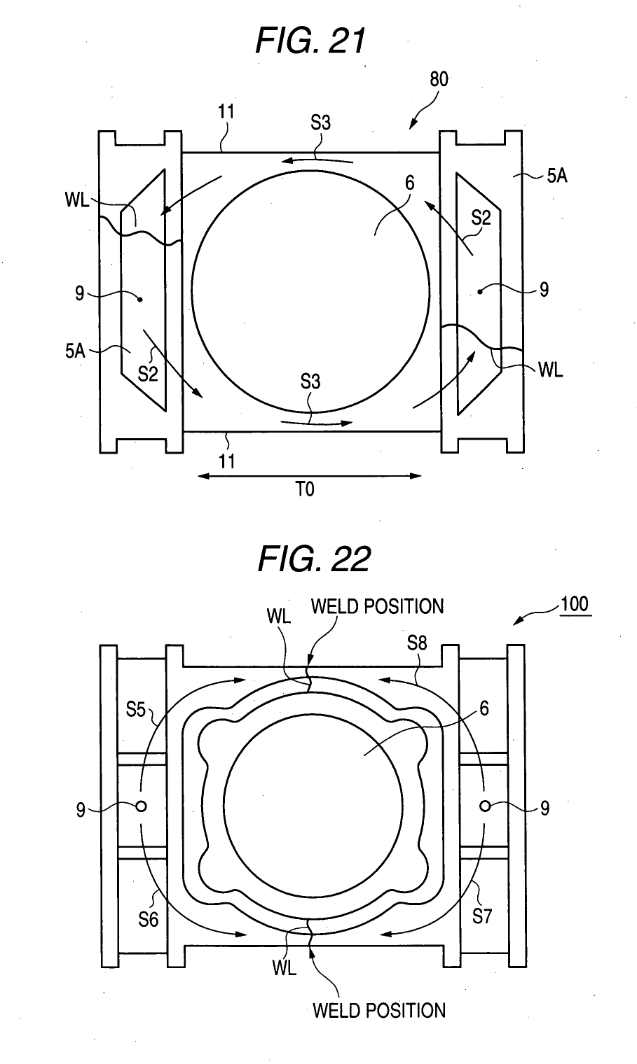

Hereinafter, a sixth embodiment of the invention is described with reference to FIGS. 19 and 21.

FIG. 19 is a perspective view illustrating a holder according to the sixth embodiment of the invention. FIG. 20 is a cross-sectional view illustrating a die, which is taken along lines X-X and Y-Y in the holder shown in FIG. 19. FIG, 21 is a schematic plan view illustrating a weld line of the holder shown in FIG. 19. FIG. 22 is a schematic plan view illustrating a weld line of a holder according to a comparative example.

A holder (resin component) 80 according to the present embodiment is constituted by modifying the holder of the third embodiment, which includes the gate mark 9 and the slide core, as a holder having twin gates and by also injecting resins into a molding die from two places to thereby mold the holder. That is, the gate marks 9, 9 according to the present embodiment are formed substantially at the central portion in the long side direction of each of the tracking coil mounting grooves 5A and 5A. Also, the gate marks 9, 9 are formed in depression portions each of which is a further concave part of a corresponding one of the tracking coil mounting grooves 5A, 5A. Similarly to the third embodiment, the gate marks 9, 9 are configured without hindrance to winding of the tracking coils therearound.

Although a concave portion, from which a slide core 84 is removed, is not shown, this concave portion is cross-sectionally triangle-shaped and has an inclined outer wall surface, as is understood from the shape of the slide core 84. The holder 80 is configured so that the stiffness and the strength of both the outer wall surface 11, 11 extending in parallel to the direction T0, in which the stiffness and the strength are needed for the holder 80, are high.

As shown in FIG. 20, a molding die (component molding die) 85 for manufacturing the holder 80 is configured so that an upper die 81 and a lower die 82 are opened from each other along the parting line P in an up-down direction of the holder 80. The two gates 9G are constituted by pin gates connected to a runner R of the upper die 81.

A slide core 84 protruded at the place opposed to the gate 9G has a transversally cross-sectionally triangle-shaped and projects into the cavity C (in a direction perpendicular to paper of FIG. 20). Also, the slide core 84 has an inclined inner wall surface 83a inclined in a rightward direction, as shown in FIG. 13. In the present embodiment, an inclination angle of the inclined inner wall surface 83a is set to be inclined by substantially 45° with respect to the parting line P.

Similarly to the inclined inner wall surface 53a according to the third embodiment, the inclined inner wall surface 83a according to the present embodiment generates two second flows S2 by changing the directions of the first flows S1 of the resin injected from the two gates 9G by 90°. After the second flows S2 flow toward the inner side wall (constituting the outer wall surfaces 11) of the cavity C, each of the directions of the second flows S2 is changed 90° along the corresponding inner side wall, so that third flows S are formed. Thus, the injected resin flows into the cavity C.

For example, weld lines WL may be formed in the holder 80, which is filled with the resin, according to the condition at injection. However, as shown in FIG. 21, the positions, at which the weld lines are formed due to the flows of the resin, are close to the two gate marks 9, respectively. Therefore, in the holder 80, the positions of the weld lines WL are deviated from a side surface area extending in the direction T0 in which the stiffness and the strength are needed for the holder. Consequently, the problem of the strength of the holder can be avoided.

In contrast, a holder 100 shown in FIG. 22 as a comparative example is the same as the sixth embodiment in that the holder is of the twin gate type that has two gate marks 9. However, in the case of the comparative example, the resin is injected without the inclined inner wall surface 83a as provided in the sixth embodiment. Thus, resins injected from the gates 9G, 9G flows while spreading depending upon the shape of the cavity. Resin flows S5 and s6 of the resin injected from one of the gates (that is, the left-side gate, in FIG. 22) collide with resin flows S8 and S7 of the resin injected from the other gate (the right-side gate in FIG. 22), respectively. Thus, the weld lines are formed substantially at the central positions of the side surface areas extending along the direction T0 in which the stiffness and the strength are needed. Consequently, the structure of the comparative example has the problem of the strength of the holder.

### SEVENTH EMBODIMENT

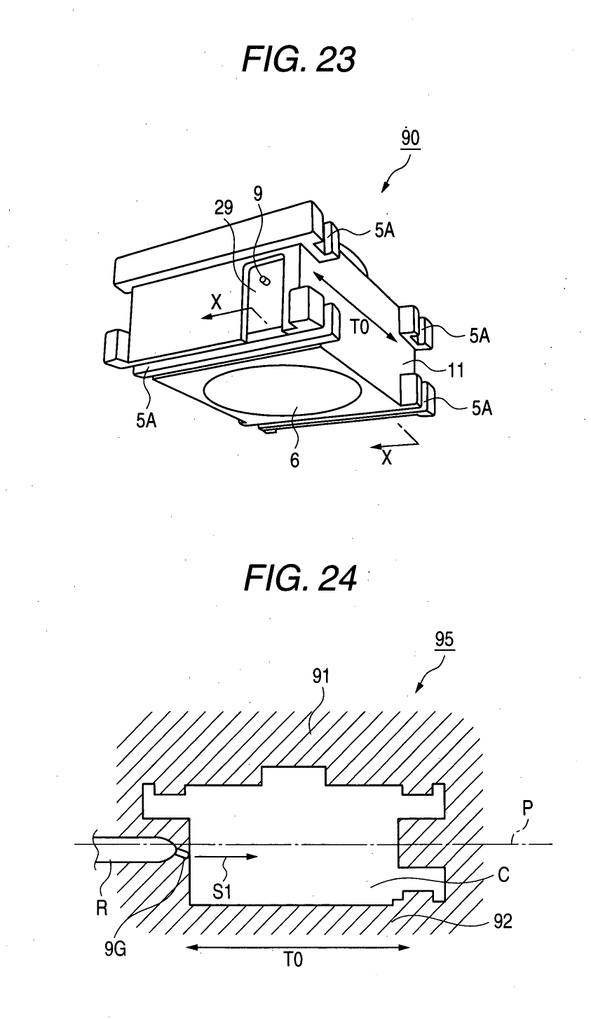

Hereinafter, a seventh embodiment of the invention is described with reference to FIGS. 23 and 24.

FIG. 23 is a perspective view illustrating a holder according to the seventh embodiment of the invention. FIG. 24 is a cross-sectional view illustrating a die, which is taken along line X-X in the holder shown in FIG. 23.

As shown in FIG. 23, a holder (resin component) 90 is configured so that a gate mark 9 is provided at a position in a depression 29 between tracking coil mounting portions 5A and 5A and is close to a parting line P.

As shown in FIG. 24, a molding die (component molding die) 95 for manufacturing the holder 90 is configured so that an upper die 91 and a lower die 92 are opened from each other along the parting line P in the up-down direction of the holder 90. The gate 9G is constituted by a submarine gate connected to a runner R provided on the parting line P between the upper die 91 and the lower die 92.

Therefore, the direction of the resin injected from the gate 9G is preliminarily set to be along a direction in which the stiffness and the strength are needed.

With this configuration, the resin flow direction can be determined by a first injection direction of injection from the gate 9G without changing the resin flow direction by the inclined inner wall surface or the like. The direction of the resin injected from the gate 9G can be set to be along the direction in which the stiffness and the strength are needed.

Thus, according to the present embodiment, the resin injected from the gate 9G does not randomly spread but flow substantially along the direction T0, in which the stiffness and the strength are necessary, while filled into the cavity. Consequently, the strength in a desired direction of the holder can be achieved by positively utilizing the anisotropy in the mechanical performance (bending elastic modulus or the like) between the resin flow direction and a direction perpendicular to the resin flow direction.

The present application claims priority from Japanese Patent Application (Patent Application No. 2004-241410) filed Aug. 20, 2004, which is hereby incorporated by reference herein in its entirety.

1. A component molding method for injection-molding a resin component, the method comprising:
injecting a resin from a gate into a cavity; and
hitting the injected resin to an inclined wall surface of the cavity to change an initial flow direction of the resin to be substantially along a direction in which stiffness of the resin component is needed to be higher than that in any other direction.

2-3. (canceled)

4. A component molding method for injection-molding a resin component, the method comprising:
injecting a resin from a gate into a cavity,
an initial flow direction of the resin injected from the gate is preliminarily adjusted to a direction in which stiffness of the resin component is needed to be higher than that in any other direction.

5. The component molding method according to claim 1,
wherein the resin component is a holder configured to hold a predetermined component.

6. A resin component formed by injection molding, comprising:
an inclined outer wall surface at a place opposed to a gate mark,
wherein the inclined outer wall surface has an inclination angle at which an initial flow direction of a resin injected into a cavity at molding of the resin component is changed to a direction in which stiffness of the resin component is needed to be higher than that in any other direction.

7. (canceled)

8. The component molding method according to claim 6,
wherein the inclination angle of the inclined outer wall surface is substantially 45° with respect to the flow direction of the resin injected from the gate.

9. The component molding method according to claim 6,
wherein the resin component is a holder configured to hold a predetermined component.

10. A resin component foxed by injection molding, comprising:
a gate mark at a position from which a resin is injected so that a direction of the resin injected from a gate at molding of the resin component is set to be along a direction in which stifffiess of the resin component is needed to be higher than that in any other direction.

11. (canceled)

12. The resin component according to claim 9, wherein the predetermined component is a lens; and
the resin component is applied to a lens drive unit which has the lens and is swingably attached to a suspension base through an elastic wire, and which is driven in a focusing direction of the lens and in a tracking direction of a scanned medium.

13. A component molding die for injection molding of a resin component, comprising:
an inclined inner wall surface at a place opposed to a gate from which a resin is injected,
wherein the inclined inner wall surface has an inclination angle at which an initial flow direction of the resin injected into the cavity at molding of the resin component is changed to a direction substantially along a direction in which stiffness of the resin component is needed to be higher than that in any other direction.

14. A component molding die for injection molding of a resin component, comprising:
an upper part;
a lower part configured to open from the upper part along a parting line; and
a gate from which a resin is injected, the gate connected to a runner on the parting line,
wherein an initial flow direction of the resin injected from the gate is set to be substantially along a direction in which stiffness of the resin component is needed to be higher than that in any other direction.
